(19) United States
(12) Patent Application Publication
(10) Pub. No.: US 2019/0277295 A1
(43) Pub. Date: Sep. 12, 2019

(54) SINGLE POWER SOURCE FOR MULTIPLE PUMPS CONFIGURATION

(71) Applicant: Halliburton Energy Services, Inc., Houston, TX (US)

(72) Inventors: Andrew Silas Clyburn, Noble, OK (US); Glenn Howard Weightman, Duncan, OK (US); Stanley V. Stephenson, Duncan, OK (US); Dick Headrick, Duncan, OK (US); Carlos Alfredo Vallejo, Humble, TX (US)

(21) Appl. No.: 16/347,281

(22) PCT Filed: Dec. 5, 2016
(86) PCT No.: PCT/US2016/064917

§ 371 Date: May 3, 2019

(51) Int. Cl. F04D 13/12; F04D 1/06; F04D 13/02; F04B 47/02; E21B 43/25; F04B 17/03; H02K 7/18

(52) U.S. Cl. CPC F04D 13/12; F04D 1/06; F04D 13/02; H02K 7/1823; E21B 43/25; F04B 17/03; F04B 47/02

(57) ABSTRACT

A single power source multiple pump system that includes a single power source driving a first pump and a second pump connected in series may provide for increased efficiencies for one or more operations of a well stimulation and servicing environment. Powering multiple pumps with a single source reduces consumption of resources while still providing the necessary power requirements. Pumps may be powered up or on in sequence so as not to exceed the power limits of the single power source. The multiple pumps may be connected in series with a gearbox to provide another arrangement or configuration. The one or more pumps down line from a pump may be disconnected when no longer in use.

### TECHNICAL FIELDS

The present disclosure relates generally to well site configuration optimization and efficiency, and more specifically (although not necessarily exclusively), to using a single power source double pump configuration to improve operations at a well site.

### BACKGROUND

In general, a well site comprises a variety of equipment for well stimulation and servicing. Each piece of equipment consumes resources at the well site including footprint, noise emissions, power, etc. Generally, a well site requires multiple pumps and each pump is associated with a separate power source which consumes several resources associated with the well site. Reduction of consumption of any resource decreases costs associated with a given operation.

### BRIEF DESCRIPTION OF THE DRAWINGS

FIG. 1 is a schematic diagram of well stimulation and servicing environment, according to one or more aspects of the present disclosure.

FIG. 2 is a diagram illustrating a single power source multiple pump system for a well stimulation and servicing environment, according to one or more aspects of the present disclosure.

FIG. 3A is a diagram illustrating a single power source multiple pump system for a well stimulation and servicing environment, according to one or more aspects of the present disclosure.

FIG. 3B is a diagram illustrating a single power source multiple pump system for a well stimulation and servicing environment, according to one or more aspects of the present disclosure.

FIG. 4 is a diagram illustrating a single power source multiple pump system for a well stimulation and servicing environment, according to one or more aspects of the present disclosure.

FIG. 5A is a diagram illustrating a single power source multiple pump system 42 for a well stimulation and servicing environment 10, according to one or more aspects of the present disclosure.

FIG. 5B is a diagram illustrating a single power source multiple pump system 42 for a well stimulation and servicing environment 10, according to one or more aspects of the present disclosure.

### DETAILED DESCRIPTION

Certain aspects and features of the present disclosure relate to optimizing one or more resources at a well site by providing transport and storage of a single power source multiple pump system. Pumps are commonly utilized for well stimulation and servicing at a well site. A pump may have an associated power source, such as an engine or turbine. Such configuration of a single pump to a single power resource requires consumption of valuable resources at the well site. For example, footprint or available surface space, noise emissions, power supply, exhaust emissions and any other resource may have an associated cost including monetary and non-monetary costs. Reduction of consumption of any one or more resources reduces costs associated with a well stimulation or servicing operation. A single power source multiple pump configuration may reduce the consumed footprint, the emitted noise, the required inventory of equipment, the emitted exhaust, and other consumption of resources associated with having a single power source multiple pump configuration.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

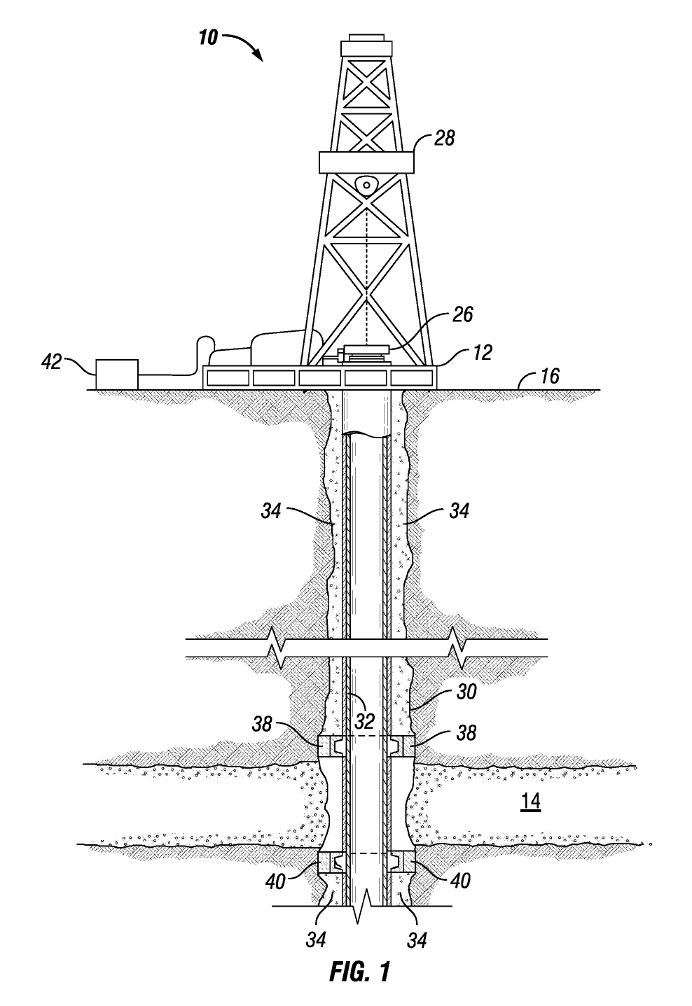

FIG. 1 is a schematic diagram of a well stimulation and servicing environment 10. Generally, well stimulation and servicing environment 10 illustrates a system for transferring material from a surface-located hydrocarbon well site 12. The well site 12 is located over a hydrocarbon bearing formation 14, which is located below a ground surface 16. While well site 12 is illustrated at a ground surface 16, the present disclosure contemplates any one or more embodiments implemented at a well site at any location, including, at sea above a subsea hydrocarbon bearing formation. At certain times during the management and operation of the well stimulation and servicing environment 10, the well site 12 may comprise a hoisting apparatus 26 and a derrick 28 for raising and lowering pipe strings such as a work string, drill string or any other mechanism for deploying downhole tools, such as a bottom hole assembly, a drill bit, sensors, or any other device or combination thereof. While well site 12 is illustrated at a ground surface 16, the present disclosure contemplates any one or more embodiments implemented at a well site at any location, including, at sea above a subsea hydrocarbon bearing formation.

The wellbore 30 is formed through various earth strata including the formation 14. A pipe or casing 32 is insertable into the wellbore 30 and may be cemented within the wellbore 30 by cement 34. A centralizer/packer device 38 may be located in the annulus between the well bore 30 and the casing 32 just above the formation 14, and a centralizer packer device 40 is located in the annulus between the wellbore 30 and the casing 32 just below the formation 14. A single power source multiple pump system 42 according to one or more aspects of the present disclosure is located at the well site 12. The single power source multiple pump system 42 is configured to provide power for one or more pumps where the one or more pumps are configured to transfer, pump or flow material including but not limited to, water, linear gel, cross-linked gel, breaker, friction reducer, surfactant, biocide, sand, proppant, diverter, or any other stimulation fluid or any combination thereof.

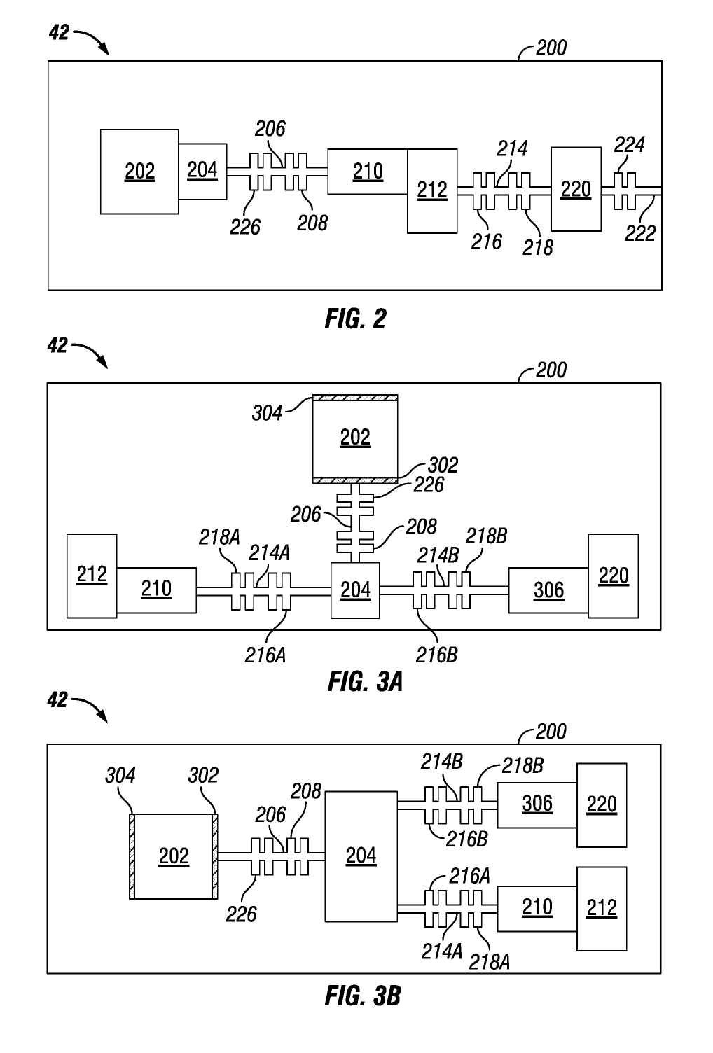

FIG. 2 is a diagram illustrating a single power source multiple pump system 42 for a well stimulation and services environment 10, according to aspects of the present disclosure. In one or more embodiments, a single power source multiple pump system 42 may comprise a platform or support surface 200 that transports, stores or otherwise supports one or more other components or equipment of the single power source multiple pump system 42. A power source 202, a gearbox 204, a gear reducer 210, pumps 212 and 220, input flanges 208 and 218, output flanges 216, 224 and 226, any one or more other components, or any combination thereof may be disposed or positioned on the platform 200. Any one or more of the power source 202, the gearbox 204, the gear reducer 210, pumps 212, 220 and input flanges 208 and 218, and output flanges 216, 224 and 226 may be selected based, at least in part, on size or footprint, weight, noise emissions, exhaust emissions, or any other property or characteristic or combination thereof. In one or more embodiments, any one or more of the components of the single power source multiple pump system 42 may be positioned or disposed on or about the platform 200 based, at least in part, on weight distribution requirements. In one or more embodiments platform 200 may comprise a truck, a tractor-trailer, a barrel, a tank, a pallet, a skid, a vessel, a railcar, any other vehicle or device for transportation and storage of the one or more components or any other suitable device for transportation, storage and support of any one or more of the single power source multiple pump system 42 components or equipment. In one or more embodiments, platform 200 comprises wheels (not shown) for ease of transportation and placement at or about a location or environment, for example, the well stimulation and servicing environment 10 of FIG. 1.

In one or more embodiments, power source 202 may comprise one or more turbines, engines, motors or any other suitable power source. The power source 202 may comprise an electric, diesel, gas (for example, natural gas), gasoline, wind, water, steam or any other suitable engine, motor or turbine for providing power to one or more pumps 212 and 220. The type of power source 202 may depend on one or more characteristics of the power source 202 or the one or more pumps 212 and 220 or any combination thereof including, but not limited to, any one or more of the efficiency of the power source 202, the required speed, torque level, power capacity, pressure or any other parameter required by the single power source multiple pump system 42, weight, size or power density of power source 202, cost of the power source 202, quality of the fuel and fuel type, load or power requirements of any one or more of the pumps 212 and 220. In one or more embodiments, the power source 202 provides power to at least one other piece of equipment at the well site or well stimulation and servicing environment 10.

Power from the power source 202 may be transferred to or used to drive pumps 212 and 220 via a gearbox 204. A drive shaft or drive line 206 from power source 202 may couple to gearbox 204. Gearbox 204 may couple to pump 212 via output flange 226, input flange 208 and gear reducer 210. For example, gearbox 204 may couple to the high-speed shaft of the power source 202 and the low-speed shaft of the pump 212. In one or more embodiments, gearbox 204 comprises a transmission. In one or more embodiments, gearbox 204 is not required.

One or more inputs (not shown) of pumps 212 and 220 may couple to corresponding input flanges and output flanges. For example, an input of pump 212 may couple to input flange 208. An output of pump 212 may couple to output flange 216. An input of pump 220 may couple to input flange 218 and an output of pump 220 may be coupled to output flange 224. Pump 212 may couple to pump 220 via a drive shaft 214, output flange 216 and input flange 218. Pump 220 may couple to output flange 224 via drive shaft 222 to drive one or more additional pumps. In one or more embodiments, one or more pumps may additionally be connected in series with pumps 212 and 220. In one or more embodiments, pumps 212 and 220 may be arranged on platform 200 in any suitable location, orientation or position. For example, pumps 212 and 220 and any other one or more pumps may be stacked, offset or askew, in line lengthwise, or otherwise, arranged on platform 200, in line crosswise on platform 200, or any combination thereof.

In one or more embodiments, pumps 212 and 220 may be timed to reduce torsion on the single power source multiple pump system 42. In one or more embodiments, power to any other pump may be discontinued. In one or more embodiments, any pump serially connected to pumps 212 and 220 may be taken offline or disconnected from the power source 202 or any pump downstream from pumps 212 and 220. For example, a third pump (not shown) may be coupled (for example, in series) to pump 220 via drive shaft 222. The third pump may be driven by the pump 220. At any time or interval during an operation driving of the third pump via the pump 220 may be discontinued or power may be disconnected from the third pump without disrupting the driving or the powering of the pumps 212 and 220. In one or more embodiments, pump 220 may be powered up or on after a predetermined time interval, after pump 212 has reached a steady state operating condition or after any other condition or state of pump 212 or pump 220. In one or more embodiments, the pump 212 and the pump 220 may be powered up based on one or more characteristics of the power source 202 or based on one or more characteristics of at least one of the pump 212 and pump 220. In one or more embodiments pumps 212 and 220 may be operated and powered at or according to any phasing.

FIG. 3A is a diagram illustrating a single power source multiple pump system 42 for a well stimulation and servicing environment 10, according to one or more aspects of the present disclosure. FIG. 3A illustrates a single power source multiple pump system 42 with similar components as illustrated in FIG. 2. Power source 202 couples to gearbox 204 via output flange 226, input flange 208 and drive shaft 206. Gearbox 204 may couple to pumps 212 and 220 or to any other one or more pumps via output flanges 216A and 216B, respectively, and input flanges 218A and 218B, respectively. The gearbox 204 may couple to a drive shaft 214A and 214B to drive pumps 212 and 220, respectively. In one or more embodiments, the gearbox 204 is not necessary and one or more power sources 202 couple to one or more pumps 212 and 220. In one or more embodiments, a gear reducer 306 may be coupled between input flange 218B and pump 220. In one or more embodiments a gear reducer 210 may be coupled between input flange 218A and pump 212.

In one or more embodiments, power source 202 may be configured, arranged, or otherwise operated such that an intake vent 302 is disposed or positioned about a first portion of the power source 202. In one or more embodiments, the first portion of the power source 202 may be engaged with or placed on the platform 200 or may be at a distal end from a second portion of the power source 202 that is engaged with or placed on the platform 200. In one or more embodiments, the second portion of the power source 202 may be engaged with or placed on the platform 200 or may be at a distal end from a portion of the power source 202 that is engaged with or placed on the platform 200. Air is flowed into or received at the power source 202 via one or more intake vents 302 and is flowed out or exhausted from the power source 202 via the one or more exhaust vents 304. In one or more embodiments, gearbox 204 may be coupled to the first portion, the second portion or any other portion of the power source 202. In one or more embodiments, the power source 202 is disposed or positioned at, on or about the platform 200 in a vertical orientation, a horizontal orientation, an orientation where a top portion of the power source 202 engages with the platform 200, or an orientation where a bottom portion of the power source 202 engages with the platform 200. In one or more embodiments, gearbox 204 comprises a splitter gearbox.

FIG. 3B is a diagram illustrating a single power source multiple pump system 42 for a well stimulation and servicing environment 10, according to one or more aspects of the present disclosure. FIG. 3A illustrates a single power source multiple pump system 42 with similar components as to FIG. 2. FIG. 3B is similar to FIG. 3A except that pump 212 is parallel with pump 220 as opposed to pump 212 in line with pump 220 as illustrated in FIG. 3A. While FIG. 3A and FIG. 3B illustrate pump 212 and pump 220 in certain orientations with respect to the gearbox 204, the present disclosure contemplates any orientation of the pumps 212, 220 with the gearbox 204. In one or more embodiments, gearbox 204 comprises a splitter gearbox.

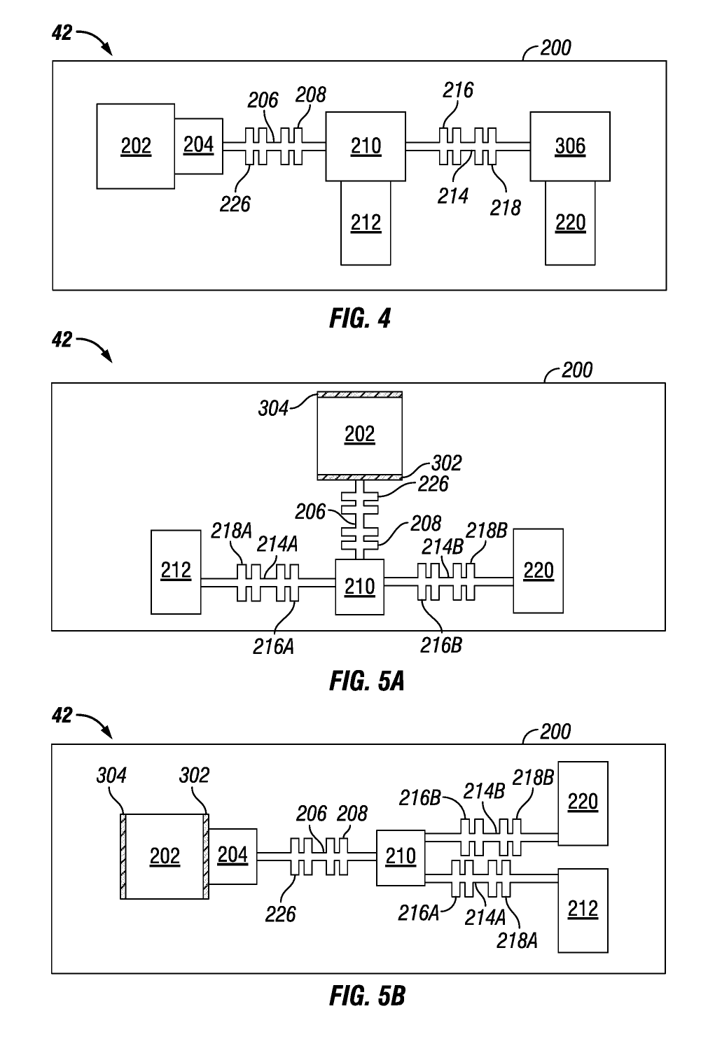

FIG. 4 is a diagram illustrating a single power source multiple pump system 42 for a well stimulation and services environment 10, according to aspects of the present disclosure. FIG. 4 illustrates a single power source multiple pump system 42 with similar components to FIG. 2. With respect to FIG. 4, power from the power source 202 may be transferred to or used to drive pumps 212 and 220. The power source 202 may couple to gearbox 204 which is coupled to the gear reducer 210 via drive shaft 206, output flange 226, input flange 208 and gear reducer 210. The gear reducer 210 may be coupled to the pump 212. Gear reducer 210 may be coupled to gear reducer 306 via drive shaft 214, output flange 216 and input flange 218. The gear reducer 306 may be coupled to pump 220.

FIG. 5A is a diagram illustrating a single power source multiple pump system 42 for a well stimulation and services environment 10, according to aspects of the present disclosure. FIG. 5A illustrates a single power source multiple pump system 42 with similar components as to FIG. 2 and FIG. 3A. Power source 202 is coupled to a gear reducer 210 via a draft shaft 206, output flange 226 and input flange 208. Gear reducer 210 is coupled to a pump 212 via drive shaft 214A, output flange 216A and input flange 218A. Gear reducer 210 may couple to pump 220 via drive shaft 214B, output flange 216B and input flange 218B. Similar to FIG. 3A and FIG. 3B, power source 202 may comprise one or more intake vents 302 and one or more exhaust vents 304. Power source 202 may be oriented as discussed above with respect to FIG. 3A. For example, as discussed with FIG. 2, the pumps 212, 220 may be stacked, askew or otherwise arranged.

FIG. 5B illustrates a single power source multiple pump system 42 with similar components as to FIG. 2, FIG. 3A and FIG. 3B. FIG. 5B is similar to FIG. 5A except that pump 212 is parallel with pump 220 as opposed to pump 212 in line with pump 220 as illustrated in FIG. 5A. While FIG. 5A and FIG. 5B illustrate pump 212 and pump 220 in certain orientations with respect to the gear reducer 210, the present disclosure contemplates any orientation of the pumps 212, 220 with the gear reducer 210, for example, as discussed with FIG. 2, the pumps 212, 220 may be stacked, askew or otherwise arranged.

While a well stimulation and servicing environment is discussed with respect to any one or more embodiments, the present disclosure contemplates that any one or more embodiments may be associated with or implemented at any type of environment requiring a pumping system. For example, any one or more embodiments of the present disclosure may be associated with or implement at gas transmission pipelines, oil transmission pipelines, water irrigation, and water transmission pipelines.

The foregoing description of certain aspects, including illustrated aspects, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

In one or more embodiments, a platform for a pumping system comprises a power source, a first pump coupled to the power source, a second pump coupled to the first pump and wherein the power source provides power to the first pump via a drive shaft and wherein the first pump drives the second pump. In one or more embodiments, the platform for the pumping system further comprises a gearbox coupled between the power source and the first pump. In one or more embodiments, the platform for the pumping system further comprises a gearbox coupled between the power source and the first pump and the second pump. In one or more embodiments, the platform for the pumping system further comprises a first input flange coupled to the first pump and a first output flange coupled to the first pump. In one or more embodiments, the platform for the pumping system further comprises a third pump coupled in series with the second pump. In one or more embodiments, the platform for the pumping system further comprises an intake vent disposed about a first portion of the power source, an exhaust vent disposed about a second portion of the power source and a gearbox coupled to the first portion of the power source. In one or more embodiments, the platform for the pumping system further comprises an intake vent disposed about a first portion of the power source, an exhaust vent disposed about a second portion of the power source, and a gearbox coupled to the second portion of the power source. In one or more embodiments, the power source comprises a turbine. In one or more embodiments, the power source is disposed on the platform in a vertical orientation. In one or more embodiments, the gearbox comprises a transmission.

In one or more embodiments, a method for powering pumps at a well site comprises disposing a power source on a platform, disposing a first pump on the platform, wherein the first pump is coupled to the power source, disposing a second pump on the platform, wherein the second pump is coupled to the first pump, providing power from the power source to the first pump via a drive shaft and driving the second pump via the first pump. In one or more embodiments, the method for powering pumps at the well site further comprises disposing a gearbox on the platform, wherein the gearbox is coupled between the power source and the first pump. In one or more embodiments, the method for powering pumps at the well site further comprises disposing a gearbox on the platform, wherein the gearbox is coupled between the power source and the first pump and the second pump. In one or more embodiments, the method of powering pumps at the well site further comprises disposing a gearbox on the platform, wherein the gearbox is coupled between the power source and the first pump and the second pump. In one or more embodiments, the method for powering pumps at the well site further comprises disposing a third pump on the platform, wherein the third pump is coupled in series with the second pump and driving the third pump via the second pump. In one or more embodiments, the method of powering pumps at the well site further comprising discontinuing driving the third pump via the second pump discontinuing driving the third pump via the second pump. In one or more embodiments, the method for powering pumps at the well site further comprises powering up the first pump to a steady state operating condition prior to powering up the second pump. The method for powering pumps at the well site further comprising powering up the first pump and the second pump based, at least in part, on at least one of one or more characteristics of the power source and one or more characteristics of at least one of the first pump and the second pump. In one or more embodiments, the method for powering pumps at the well site further comprising providing power to at least one other equipment at the well site via the power source. In one or more embodiments, the first pump and the second pump are disposed on the platform by stacking the first pump and the second pump.

What is claimed is:

1. A platform for a pumping system comprising:
a power source;
a first pump coupled to the power source;
a second pump coupled to the first pump; and
wherein the power source provides power to the first pump via a drive shaft, and wherein the first pump drives the second pump.

2. The platform for a pumping system of claim 1, further comprising a gearbox coupled between the power source and the first pump.

3. The platform for a pumping system of claim 1, further comprising a gearbox coupled between the power source and the first pump and the second pump.

4. The platform for a pumping system of claim 1, further comprising:
a first input flange coupled to the first pump; and
a first output flange coupled to the first pump.

5. The platform for a pumping system of claim 1, further comprising a third pump coupled in series with the second pump.

6. The platform for a pumping system of claim 1, further comprising:
an intake vent disposed about a first portion of the power source;
an exhaust vent disposed about a second portion of the power source; and
a gearbox coupled to the first portion of the power source.

7. The platform for a pumping system of claim 1, further comprising:
an intake vent disposed about a first portion of the power source;
an exhaust vent disposed about a second portion of the power source; and
a gearbox coupled to the second portion of the power source.

8. The platform for a pumping system of claim 1, wherein the power source comprises a turbine.

9. The platform for a pumping system of claim 1, wherein the power source is disposed on the platform in a vertical orientation.

10. The platform for a pumping system of claim 1, wherein the gearbox comprises a transmission.

11. A method for powering pumps at a well site comprising:
disposing a power source on a platform;
disposing a first pump on the platform, wherein the first pump is coupled to the power source;
disposing a second pump on the platform, wherein the second pump is coupled to the first pump;
providing power from the power source to the first pump via a drive shaft; and
driving the second pump via the first pump.

12. The method for powering pumps at a well site of claim 11, further comprising disposing a gearbox on the platform, wherein the gearbox is coupled between the power source and the first pump.

13. The method for powering pumps at a well site of claim 11, further comprising disposing a gearbox on the platform, wherein the gearbox is coupled between the power source and the first pump and the second pump.

14. The method for powering pumps at a well site of claim 12, further comprising disposing a gearbox on the platform, wherein the gearbox is coupled between the power source and the first pump and the second pump.

15. The method for powering pumps at a well site of claim 11, further comprising:
disposing a third pump on the platform, wherein the third pump is coupled in series with the second pump; and
driving the third pump via the second pump.

16. The method for powering pumps at a well site of claim 15, further comprising discontinuing driving the third pump via the second pump.

17. The method for powering pumps at a well site of claim 11, further comprising powering up the first pump to a steady state operating condition prior to powering up the second pump.

18. The method for powering pumps at a well site of claim 11, further comprising powering up the first pump and the second pump based, at least in part, on at least one of one or more characteristics of the power source and one or more characteristics of at least one of the first pump and the second pump.

19. The method for powering pumps at a well site of claim 11, further comprising providing power to at least one other equipment at the well site via the power source.

20. The method for powering pumps at a well site of claim 11, wherein the first pump and the second pump are disposed on the platform by stacking the first pump and the second pump.
